(19) United States
(12) Patent Application Publication
(10) Pub. No.: US 2005/0231028 A1
(43) Pub. Date: Oct. 20, 2005

(54) Master cylinder

(76) Inventors: Kaoru Tsubouchi, Kariya (JP); Hideaki Iijima, Kariya (JP); Katsuhiro Mita, Kariya (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/101,500

(22) Filed: Apr. 8, 2005

(30) Foreign Application Priority Data
Apr. 15, 2004 (JP) 2004-120632
Aug. 26, 2004 (JP) 2004-246448

(51) Int. Cl. B60T 8/34

(52) U.S. Cl. 303/115.1

(57) ABSTRACT

A master cylinder includes a cylinder body, a piston slidably received in the cylinder body to define a pressure chamber in the cylinder body, and a reservoir coupled to the cylinder body. The reservoir has a downwardly extending protrusion formed with a hole through which the interior of the reservoir communicates with the pressure chamber, and a shoulder at the top end of the hole. A valve body is received in the hole and includes a disk adapted to be moved into and out of contact with the bottom surface of the protrusion, and extensions extending upwardly from the disk and inserted in the hole. Each extension has an engaging portion protruding upwardly from the hole and engageable with the shoulder. The valve body is movable upwardly until the fluid passage defined between the disk and the protrusion is closed under the back flow pressure of hydraulic fluid toward the reservoir. The disk is formed with an orifice through which hydraulic fluid can flow from the pressure chamber into the reservoir when the fluid passage is closed.

### BACKGROUND OF THE INVENTION

The present invention relates to a master cylinder used in a vehicle hydraulic brake system.

Many of today's motor vehicles are equipped with various automatic braking functions including traction control (TRC) and electronic stability control (ESC).

Some of vehicle hydraulic brake systems having one or more of such automatic brake functions are designed to draw hydraulic fluid (brake fluid) from the reservoir through a pressure chamber defined in the master cylinder.

It is desired that this type of hydraulic brake system have a master cylinder structured such that hydraulic fluid can flow from the reservoir into the pressure chamber without encountering any substantial resistance while the master cylinder is inoperative, and any fluid flow (reverse flow) from the pressure chamber toward the reservoir during an initial stage of braking is restricted. A master cylinder that satisfies this requirement is disclosed in JP patent publication 2000-142365.

One of the master cylinders disclosed in this publication (shown in FIG. 9 of the publication) is shown in FIG. 10. As shown, this master cylinder includes a throttle valve mechanism 35 received in a valve chamber 37 which is a part of a passage through which a reservoir communicates with a pressure chamber. The valve mechanism 35 includes a floating valve body 38. When the pressure in the pressure chamber falls below the pressure in the reservoir, the valve mechanism 35 is adapted to open, allowing hydraulic fluid to flow from the reservoir into the pressure chamber (in the direction of the solid arrow in FIG. 10).

When hydraulic fluid flows in reverse, i.e. from the pressure chamber into the reservoir, the valve mechanism 35 closes. That is, the floating valve body 38 is seated on a valve seat 40 under the force of a tension spring 36. Hydraulic fluid thus flows through a restricted passage 39 at a restricted flow rate.

Thus, in spite of the fact that hydraulic fluid can be smoothly supplied from the reservoir into the pressure chamber while the master cylinder is inoperative, as soon as the master cylinder is actuated, brake pressure is instantly generated in the pressure chamber, thereby minimizing the idle stroke of the piston at the initial stage of braking. Suitable reaction force is applied to the input members of the brake system due to the fact that hydraulic fluid flows through the restricted passage at a restricted flow rate. This prevents self-induced vibrations and noise produced at the initial stage of actuation of a negative-pressure booster (if the brake system has such a booster) due to insufficient reaction force. This in turn ensures smooth brake pedal feel.

Since the floating valve body 38 is coupled to the reservoir through the tension spring 36, the valve body 38 can be handled together with the reservoir. Once the floating valve body 38 is coupled to the reservoir through the spring 36, it is automatically positioned relative to the valve seat 40 of the reservoir with high accuracy. This ensures stable operation of the throttle valve mechanism.

In this arrangement, since the floating valve body 38 is coupled to the reservoir through the tension spring 36 so as to be seated on the valve seat 40 under the force of the tension spring 36, in order to open the valve mechanism, it is necessary to apply fluid pressure greater than the force of the spring 36 to the valve body 38. Thus, the spring 36 offers resistance to the flow of hydraulic fluid from the reservoir into the pressure chamber. This means that compared to a valve assembly having no such tension spring, the throttle valve mechanism 35 can be opened less sufficiently while the master cylinder is inoperative, so that hydraulic fluid cannot necessarily be drawn sufficiently smoothly from the reservoir into the pressure chamber.

Productivity is not good, either, because an additional assembling step of mounting the tension spring 36 is necessary. Moreover, since the throttle valve mechanism 35 is normally closed, foreign matter that passes through a filter and flows into the reservoir tends to deposit on the floating valve body 38. If such foreign matter gets stuck between the valve body 38 and the valve seat 40, a gap may develop between the valve body 38 and the valve seat 40 that is even greater in sectional area than the restricted passage 39. Thus, when the brake pedal is depressed, hydraulic fluid can flow from the pressure chamber into the reservoir not only through the restricted passage 39 but through the gap present between the valve body 38 and the valve seat 40. This makes it difficult to sufficiently restrict the reverse fluid flow from the pressure chamber into the reservoir.

An object of the present invention is to provide a master cylinder having a valve mechanism which is simple in structure and easy to assemble and which makes it possible to more smoothly draw hydraulic fluid from the reservoir into the pressure chamber, thereby improving response of automatic braking, and can effectively check a back flow of hydraulic fluid from the pressure chamber into the reservoir, thereby improving brake pedal feel.

### SUMMARY OF THE INVENTION

According to the present invention, there is provided a master cylinder comprising a cylinder body, a piston slidably received in the cylinder body to define a pressure chamber in the cylinder body, a reservoir coupled to the cylinder body, the reservoir having a downwardly extending protrusion formed with a hole through which the interior of the reservoir communicates with the pressure chamber, and a shoulder at a top end of the hole, and a valve body received in the hole, the valve body comprising a flat plate portion adapted to be moved into and out of contact with a bottom surface of the downwardly extending protrusion, thereby selectively opening and closing a fluid passage defined between the flat plate portion and the downwardly extending protrusion, and an elastically deformable extension extending upwardly from the flat plate portion and inserted in the hole, the extension having an engaging portion protruding upwardly from the hole and engageable with the shoulder, the valve body being movable upwardly until the fluid passage is closed under a back flow pressure of hydraulic fluid toward the reservoir, the master cylinder further including a restricted passage through which the reservoir communicates with the pressure chamber when the fluid passage is closed.

To mount the valve body to the reservoir, its extension is inserted into the hole formed in the downwardly extending protrusion while elastically deforming it until the engaging portion engages the shoulder. Thus, the hole formed in the downwardly extending protrusion of the reservoir may be so simple in shape that it can be formed in a mold. The valve body can be mounted to the reservoir in an extremely simple manner. Since the valve body is a one-piece member, it can also be formed in a mold. This improves overall productivity of the master cylinder.

Since the distance by which the valve body can move vertically is determined by the distance between the flat plate portion and the engaging portion, the stroke of the valve body can be made constant, so that it operates stably.

The restricted passage may be an orifice formed in the flat plate portion of the valve body. Such an orifice can be formed easily. Alternatively, the restricted passage may be a groove formed in one of surfaces of the flat plate portion and the downwardly extending protrusion that are adapted to be moved into and out of contact with each other to extend from its outer to inner edge.

Preferably, the downwardly extending protrusion is formed with a first conical surface on its bottom end, and the flat plate portion is formed with a second conical surface on an upper portion of its outer periphery, the second conical surface being configured to be brought into sealing contact with the first conical surface, thereby closing the fluid passage. With this arrangement, since the conical, and thus tapered, surfaces are brought into contact with other, their contact pressure is high even while the back flow pressure is low. Thus, even if the valve body is small, it can reliably seal the fluid. Since the sealing surfaces are tapered, foreign matter is less likely to deposit thereon. In other words, foreign matter is less likely to get stuck between the sealing surfaces. This prevents poor sealing and thus deterioration of brake pedal feel.

Preferably, the valve body is made of a material having a greater specific gravity than hydraulic fluid. With this arrangement, the flat plate portion is normally allowed to separate from the downwardly extending protrusion under the weight of the valve body, thereby opening the fluid passage. Thus, hydraulic fluid can be more smoothly drawn into the pressure chamber from the reservoir.

Preferably, the valve body is formed with a recess on a bottom surface thereof to bear the back flow pressure. The back flow pressure thus acts more effectively on the valve body, so that the valve body can be moved to its closed position more quickly.

From a second aspect of the invention, there is provided a master cylinder comprising a cylinder body, a piston slidably received in the cylinder body to define a pressure chamber in the cylinder body, a reservoir coupled to the cylinder body, the piston being configured to shut off communication between the pressure chamber and the reservoir when moved under an external force, thereby pressurizing hydraulic fluid in the pressure chamber and discharging the thus pressurized hydraulic fluid from the pressure chamber through an outlet port, and
a valve mechanism provided in a fluid passage through which the pressure chamber communicates with the reservoir, the valve mechanism comprising a flow restrictor through which hydraulic fluid can flow from the pressure chamber into the reservoir in a restricted amount while a back flow pressure of hydraulic fluid from the pressure chamber toward the reservoir is low, and a relief valve configured to open if the back flow pressure exceeds a predetermined threshold, thereby allowing hydraulic fluid to flow from the pressure chamber into the reservoir through the relief valve.

With this arrangement, while the back flow pressure is low, the flow restrictor controls the flow amount from the pressure chamber to the reservoir to a restricted small level. If the back flow pressure exceeds the predetermined threshold, the relief valve will open, thereby preventing excessive pressure rise in the pressure chamber. The flow restrictor and the relief valve thus cooperate to ensure good brake pedal feel and high reliability of seal portions by preventing excessive pressure rise in the pressure chamber.

The following are preferable arrangements of the master cylinder according to the second aspect of the present invention.
1) The valve mechanism is configured to remain open, thereby opening the fluid passage, while the master cylinder is inoperative, and close when hydraulic fluid begins to flow from the pressure chamber toward the reservoir, thereby allowing hydraulic fluid to flow only through the flow restrictor, the valve mechanism further comprising a movable valve body and a valve seat, the flow restrictor being formed in one of the valve body and the valve seat, or defined between the valve body and the valve seat.
2) The movable valve body of the valve mechanism is moved away from the valve seat under its own weight while the master cylinder is inoperative.
3) The valve mechanism further comprises a movable valve body and a valve seat, the relief valve is an integral part of the movable valve body.
4) The valve mechanism further comprises a valve body and a valve seat, the relief valve being a duck bill type valve comprising a slit formed in the valve body and configured to open if the back flow pressure exceeds the predetermined threshold.
5) The relief valve comprises an elastic member which is an integral part of a seal member disposed between the cylinder body and a portion of the reservoir connected to the cylinder body, and a valve seat formed with a relief hole, the elastic member normally closing the relief hole, and being configured to separate from the valve seat, thereby opening the relief hole if the back flow pressure exceeds the predetermined threshold.
6) The flow restrictor is provided on the reservoir.

With the arrangement 1), since the valve mechanism is open while the master cylinder is inoperative, hydraulic fluid can be smoothly drawn into the pressure chamber from the reservoir during automatic braking. Thus, automatic braking can be performed with good responsiveness.

With the arrangement 2), since the movable valve body of the valve member is kept at its open position under its own weight, the valve member needs no biasing member for keeping the valve body at its open position, and thus is simple in structure.

With the arrangements 4)-7), it is possible to further reduce the number of parts and/or further simplify the structure.

### BRIEF DESCRIPTION OF THE DRAWINGS

Other features and objects of the invention will become apparent from the following description made with reference to the accompanying drawings, in which:

FIG. 1 is a sectional view of a master cylinder of a first embodiment according to the present invention;

FIG. 2 is a partial enlarged sectional view of the master cylinder of FIG. 1, showing one of its two valve bodies;

FIG. 3 is a perspective view of the valve body of FIG. 2;

FIG. 4 is a partial enlarged sectional view of a valve body formed with a different restricted passage;

FIG. 5 is a sectional view of a master cylinder of a second embodiment according to the present invention;

FIG. 6A is a plan view of one of two valve mechanisms of the master cylinder of FIG. 5;

FIG. 6B is a sectional view taken along line X-X of FIG. 6A;

FIG. 7A is a plan view of a different valve mechanism;

FIG. 7B is a sectional view taken along line Y-Y of FIG. 7A;

FIG. 8A is a plan view of a still different valve mechanism;

FIG. 8B is a sectional view taken along line Z-Z of FIG. 8A;

FIG. 9 is a sectional view of a yet different valve mechanism; and

FIG. 10 is a sectional view of a throttle valve disclosed in JP patent publication 2000-142365.

### DETAILED DESCRIPTION OF THE PREFERRED EMBODIMENTS

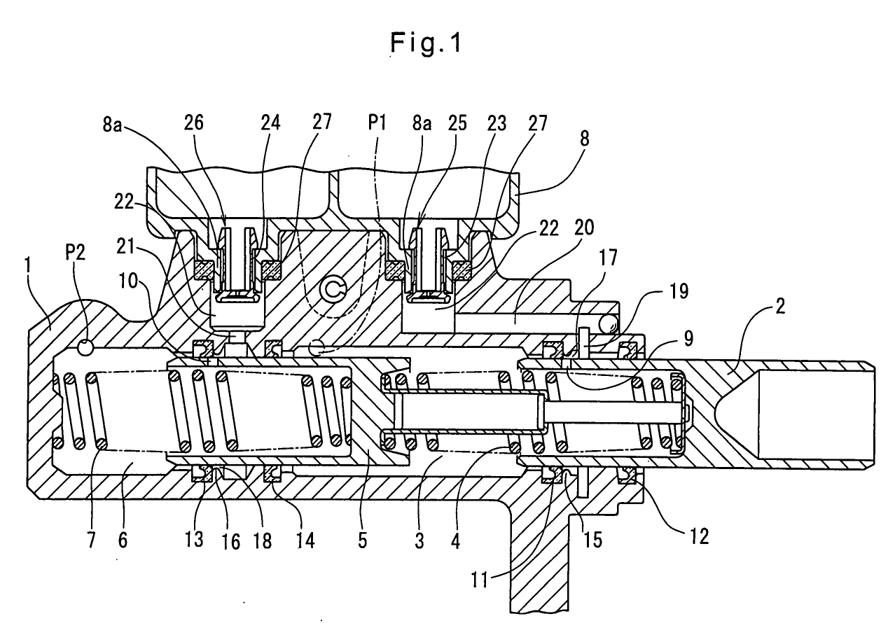

Now referring to the drawings, FIGS. 1-4 show the master cylinder of the first embodiment according to the present invention. It includes a cylinder body 1, a primary piston 2 slidably mounted in the cylinder body 1, and a secondary piston 5 slidably mounted in the cylinder body 1 forwardly (leftwardly in FIG. 1) of the primary piston 2. In the cylinder body 1, a first pressure chamber 3 is defined between the primary and secondary pistons 2 and 5, and a second pressure chamber 6 is defined between the secondary piston 5 and the end wall of the cylinder body 1. Brake hydraulic pressure is generated in each of the first and second pressure chambers 3 and 6 when hydraulic fluid filling the respective pressure chambers 3 and 6 is pressurized by the primary piston 2 and the secondary piston 5, respectively. Return springs 4 and 7 for the primary and secondary pistons 2 and 5 are mounted in the first and second pressure chambers 3 and 6, respectively. The master cylinder further includes a reservoir 8. Hydraulic pressures generated in the first and second pressure chambers 3 and 6 are discharged through output ports P1 and P2, respectively.

Primary cups 11 and 13, a secondary cup 12, and a pressure cup 14 are received in grooves formed in the inner periphery of the cylinder body 1, with the primary cup 11 sealing the outer periphery of the primary piston 2, the secondary cup 12 sealing the outer periphery of the primary piston 2, thereby isolating the interior of the cylinder body 1 from the outer air, the primary cup 13 sealing the outer periphery of the secondary piston 5, and the pressure cup 14 sealing the outer periphery of the secondary piston 5, thereby isolating the first pressure chamber 3 from the reservoir 8.

Immediately rearwardly (rightwardly in FIG. 1) of the respective primary cups 11 and 13, annular walls 15 and 16 are integrally formed on the inner periphery of the cylinder body 1 to support the backs of the primary cups 11 and 13.

The annular walls 15 and 16 have inner diameters greater than the outer diameters of the primary and secondary pistons 2 and 5 to define gaps between the annular walls 15 and 16 and the primary and secondary cups 2 and 5.

The primary piston 2 and the secondary piston 5 are formed with a plurality of circumferentially aligned piston ports 9 and 10 adapted to communicate with annular passages 17 and 18 formed behind the annular walls 15 and 16, respectively.

The cylinder body 1 is formed with an annular groove 19, fluid passages 20 and 21 and holes 22 through which the annular passages 17 and 18 communicate with the reservoir 8. The fluid passage 20 extends substantially parallel to the axis of the cylinder body 1.

The reservoir 8 has on its bottom a pair of downwardly extending, cylindrical protrusions 8a received in the respective holes 22 and having holes 23 and 24 centrally formed therein. Through the holes 23 and 24, the interior of the reservoir 8 communicates with the first and second pressure chambers 3 and 6, respectively. Valve bodies 25 and 26 are received in the respective holes 23 and 24. Since the valve bodies 25 and 26 as well as the holes 23 and 24 are identical in structure to each other, description is made only of the valve body 25, the hole 23, and elements associated with the valve body 25 and the hole 23.

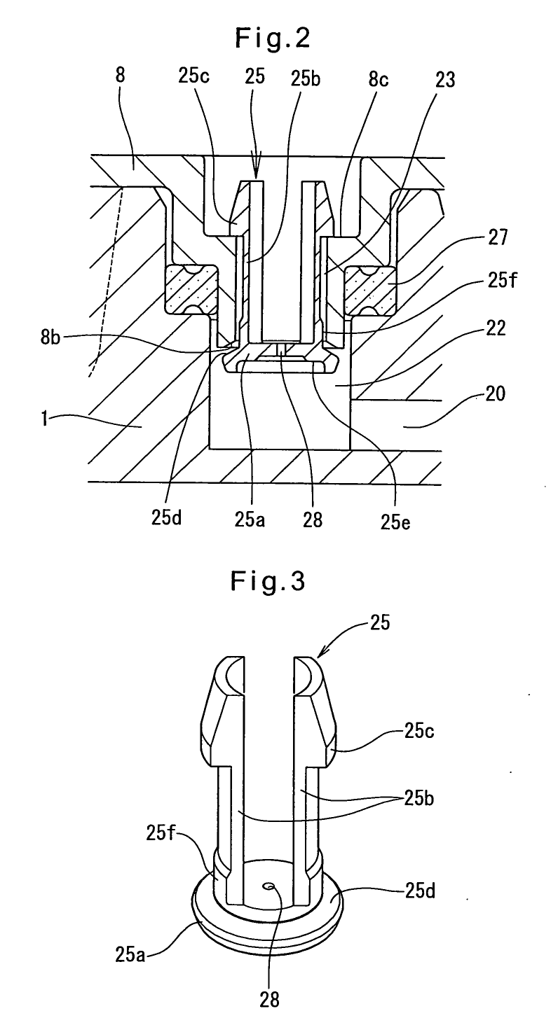

A seal member 27 is disposed between the protrusion 8a and the hole 22 to airtightly seal the joint portion of the reservoir 8 and the cylinder body 1. As shown in FIG. 2, the protrusion 8a has a conical bottom end face 8b. Between the interior of the reservoir 8 and the hole 23, a flat surface 8c or shoulder is formed.

As shown in FIG. 3, the valve body 25 comprises a disk 25a, and a plurality of extensions 25b extending upwardly from the top surface of the disk 25a at portions spaced radially inwardly from its outer edge. At its top end, each extension 25b has a radially outwardly extending projection 25c (which may be in the shape of a barb as shown). A restricted passage 28 is formed centrally in the disk 25a. On the upper half portion of the radially outer periphery of the disk 25a, a conical surface 25d complementary in shape to the conical end face 8b is formed. A recess 25e is formed in the bottom surface of the disk 25a. At bottom end portions, the extensions 25b have large-diameter guide portions 25f that can be smoothly guided along the inner wall of the hole 23.

To mount the valve body 25 in the hole 23 as shown in FIG. 2, its extensions 25b are inserted into the hole 23 from below. When the extensions 25b are inserted into the hole 23, the projections 25c are pushed radially inwardly by abutting the inner wall of the hole 23, while resiliently deforming the extensions 25b. When the projections 25c subsequently come out of the hole 23 from its top end, they will expand radially outwardly under the restoring force of the extensions 25b, thus engaging the flat surface 8c. The valve body 25 is thus held in position. In this state, the conical surface 25d, which serves as a sealing surface, is separate from the conical surface 8b, which serves as a valve seat, the gap therebetween serving as a passage through which the interior of the reservoir 8 communicates with the first pressure chamber 3.

The valve body 25 is made of a material having a greater specific gravity than hydraulic fluid, such as a nylon-family material. The valve body 25 may be formed by injection molding. Since the valve body 25 is greater in specific gravity than hydraulic fluid, the valve body 25 is normally kept open. When the master cylinder is actuated with the valve body 25 open, hydraulic fluid is allowed to flow from the pressure chamber back into the reservoir 8 until the piston ports 9 and 10 close, thereby pushing up the valve body 25 until the conical surface 25d is pressed against the conical surface 8b. The gap therebetween is thus closed, so that hydraulic fluid now flows from the pressure chamber into the reservoir only through the restricted passage 28 in a restricted and controlled amount. This imparts smooth and suitable brake pedal feel. Since the valve body 25 is normally kept open because it is greater in specific gravity than hydraulic fluid, during e.g. automatic braking, hydraulic fluid can be smoothly drawn from the reservoir into the pressure chamber without encountering any substantial resistance.

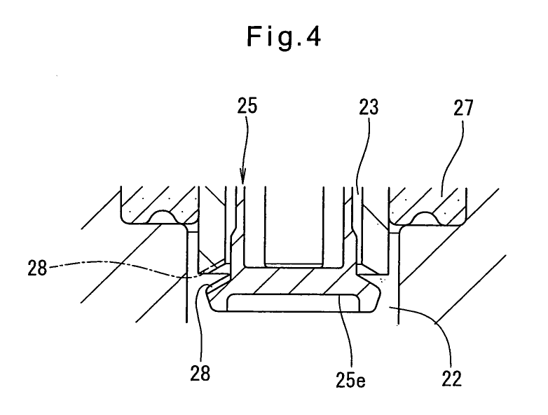

The surfaces 8b and 25d are preferably conical surfaces as shown because foreign matter is less likely to deposit on such conical surfaces. But they may be flat surfaces instead because flat surfaces are easier to form. The recess 25e serves to guide fluid flow from the pressure chamber toward the reservoir into the restricted passage 28, but may be omitted. The restricted passage 28 may be a narrow groove formed in one of the sealing surfaces that are adapted to be pressed against and separate from each to open and close the valve body, e.g. one of the conical surfaces 25d and 8b so as to extend from the radially outer to inner edge of the protrusion 8a. A typical such groove (i.e. restricted passage 28) is shown in FIG. 4.

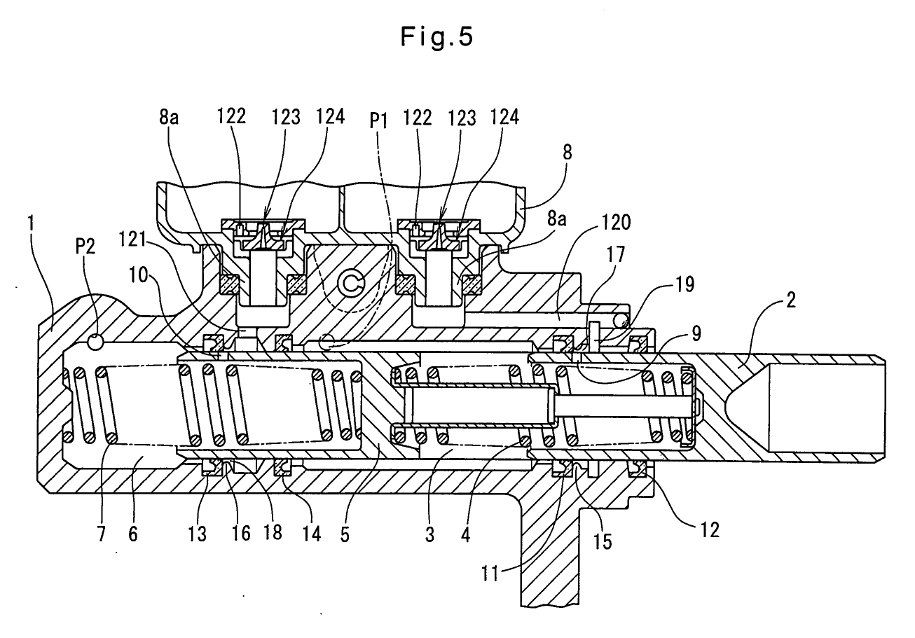

FIGS. 5-9 show different master cylinders according to the present invention. They are identical in structure to the embodiment of FIGS. 1-4 except for the throttle valve mechanisms provided between each pressure chamber and the reservoir. Thus, elements identical to those of the embodiment of FIGS. 1-4 are denoted by identical numerals and their description is omitted.

In a vehicle hydraulic brake system, due to kickback from the road wheel cylinders or according to the mode of travel stability control, hydraulic fluid may rapidly and violently flow back into the master cylinder. In the arrangement of the first embodiment, even if hydraulic fluid rushes into the master cylinder, such hydraulic fluid cannot be returned into the reservoir in a sufficiently short period of time, because in such a situation, the valve bodies are closed, so that hydraulic fluid can flow only through the narrow restricted passages thereof. This may cause high pressure to be generated in the master cylinder and any line between the valve bodies and the wheel cylinders. Such high hydraulic pressure will increase the possibility of leakage of hydraulic fluid through seals at joint portions between the reservoir and the cylinder body or through cups isolating the interior of the cylinder from the atmosphere.

To avoid this problem, the master cylinder of any of the embodiments of FIGS. 5-9 includes, between each pressure chamber and the reservoir, a restricted passage 122 similar to the restricted passage 28 of the embodiment of FIGS. 1-4, and a relief valve 123 provided parallel to or in series with the restricted passage 122.

The relief pressure (valve-opening pressure) of the relief valve 123 is determined to be greater than the maximum pressure applied thereto by the fluid in the pressure chambers when the master cylinder is actuated until the piston ports 9 and 10 are closed. Thus, while the brake pedal is being operated by the driver, the relief valve 123 is kept shut, so that hydraulic fluid can flow from the pressure chambers into the reservoir only through the restricted passages 122 in a restricted amount.

The relief valve 123 and the restricted passage 122 provided between the first pressure chamber 3 and the reservoir 8 are identical in structure to those provided between the second pressure chamber 3 and the reservoir 8. Thus, only the former is described below.

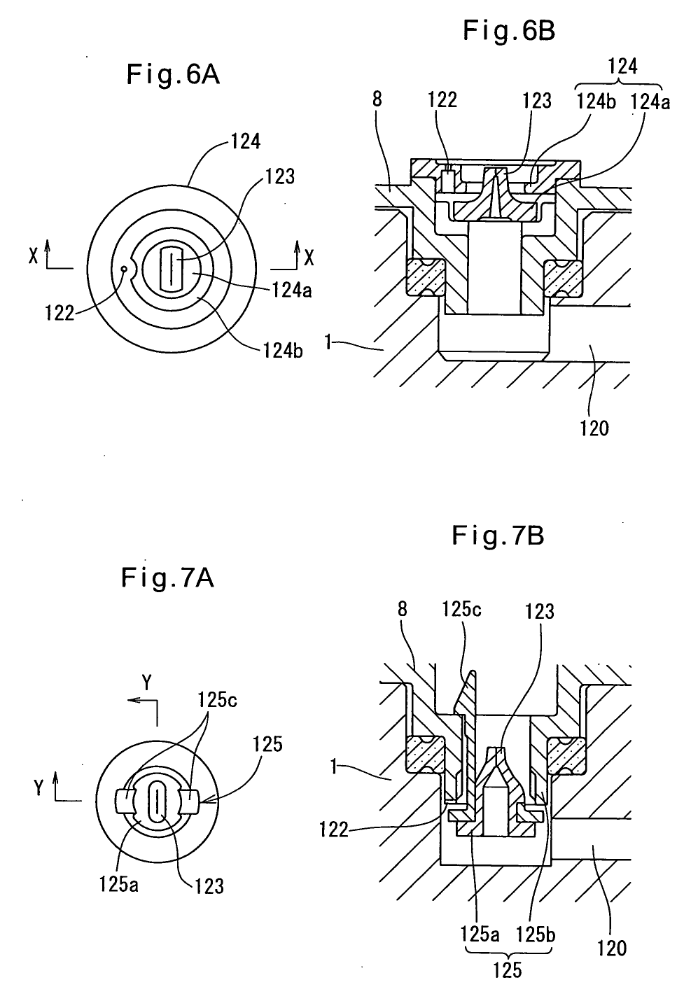

In the embodiment of FIG. 6, a valve mechanism 124 comprising a movable valve body 124a and a valve seat 124b which is a portion of the wall of the reservoir 8 is received in a fluid passage (which may be formed in the reservoir 8 as shown) through which the pressure chamber communicates with the interior of the reservoir. The restricted passage 122 (orifice) is formed in the valve seat 124b.

In the embodiment of FIG. 7, a valve mechanism 125 received in a fluid passage between the pressure chamber and the reservoir comprises a movable valve body 125a comprising a disk portion and two extensions 125c vertically extending from the top surface of the disk portion and slidably inserted in a hole formed in a cylindrical protrusion 8a (see FIG. 5) formed on the bottom of the reservoir 8 so as to be connected to the cylinder body 1, and a valve seat 125b formed at the bottom end of the cylindrical protrusion 8a (FIG. 5). A radial, narrow groove is formed in one of the movable valve body 125a and the valve seat 125b so as to define the restricted passage 122 between the valve body 125a and the valve seat 125b when the former is seated on the latter.

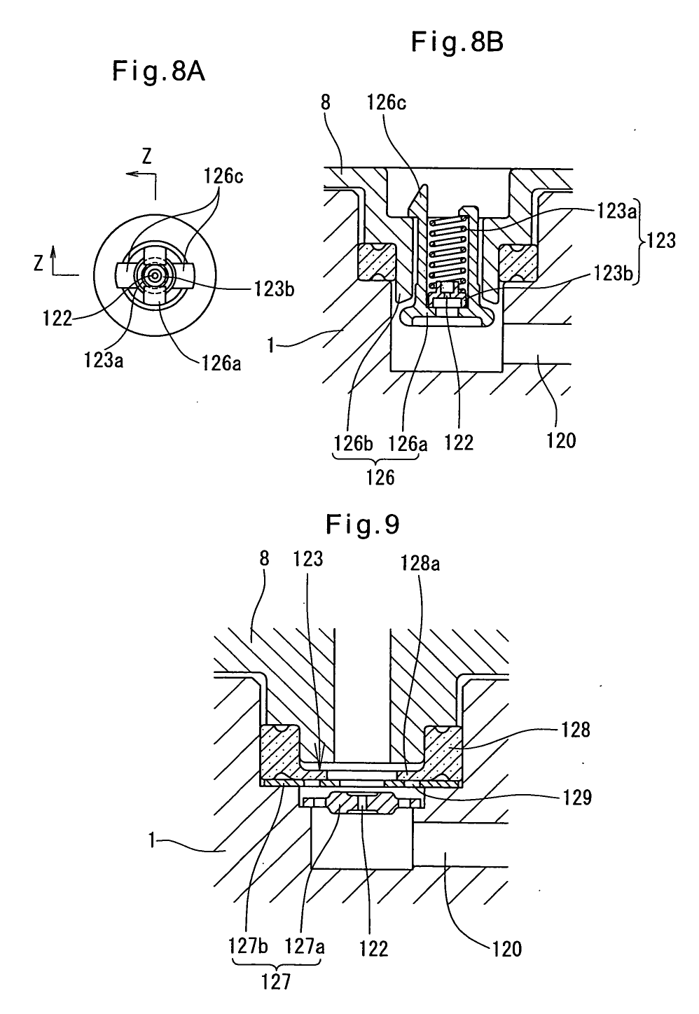

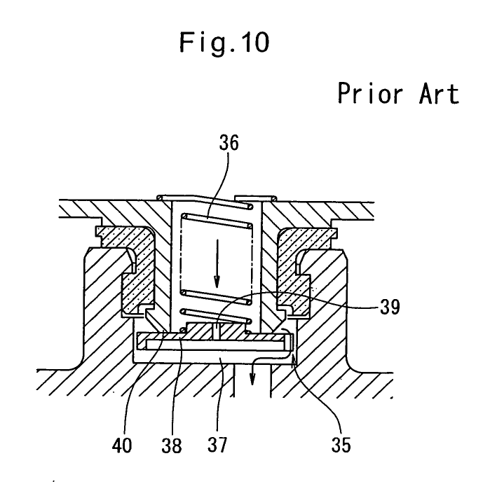

In the embodiment of FIG. 8, a valve mechanism 126 received in a fluid passage between the pressure chamber and the reservoir comprises a movable valve body 126a comprising a disk portion and two extensions 126c vertically extending from the top surface of the disk portion and slidably inserted in a hole formed in a cylindrical protrusion 8a formed on the bottom of the reservoir so as to be connected to the cylinder body 1, and a valve seat 126b formed at the bottom end of the cylindrical protrusion 8a. The relief valve 123 is mounted in the movable valve body 126a and includes its own valve body 123b. The restricted passage 122 is formed in the valve body 123b.

In the embodiment of FIG. 9, a valve mechanism 127 comprising a movable valve body 127a and a valve seat 127b is received in a fluid passage between the pressure chamber and the reservoir. The restricted passage 122 is formed centrally in the movable valve body 127a.

The relief pressure of the relief valve in any of the embodiments of FIGS. 5-9 may be determined by spring force or elastic force of rubber. The movable valve body 124 of the embodiment of FIG. 6 is made of rubber and has a slit adapted to open under a pressure higher than its predetermined relief pressure, thereby releasing pressure in the pressure chamber into the reservoir. The movable valve body 124 thus acts as the relief valve 123. The relief valve 123 in this case is a duck bill type valve. In the embodiment of FIG. 7, too, part of the movable valve body 125a is made of rubber and forms a duck bill type valve, i.e. the relief valve 123.

In the embodiment of FIG. 8, the relief valve 123 comprises the valve body 123b, which is, as mentioned above, received in the movable valve body 126a, and a spring 123a which is also received in the movable body 126a and biases the valve body 123b downwardly to its closed position. If the back flow pressure exceeds the relief pressure of the relief valve 123, the valve body 123b will separate from the movable valve body 126a, thus opening the relief passage.

The relief valve 123 of the embodiment of FIG. 9 comprises a valve body 128a which is actually an integral part of a rubber seal (grommet) 128 disposed between the cylindrical protrusion 8a formed on the bottom of the reservoir and the cylinder body 1, and the valve seat 127b. The valve seat 127b is formed with a relief hole 129. Normally, the valve body 128a is seated on the valve seat 127b, thereby closing the relief hole 129.

If the back flow pressure exceeds the relief pressure of the relief valve 123, the valve body 128a is elastically deformed due to a pressure difference and separates from the valve seat 127b, thereby opening the relief hole 129.

Any of the movable valve bodies 124a, 125a, 126a and 127a of the valve mechanisms 124 to 127 of FIGS. 6-9 is made of a material having a greater specific gravity than hydraulic fluid (such as a polyamide resin or a rubber-resin composite material). Thus, while the master cylinder is inoperative, the valve mechanism and thus the fluid passage between each of the first and second pressure chambers and the reservoir are kept open. This ensures smooth flow of hydraulic fluid from the reservoir into the first and second pressure chambers without encountering any substantial resistance during automatic braking and then to the brake control system.

When the brake pedal is depressed by the driver, and hydraulic fluid in the pressure chambers begins to flow toward the reservoir under low pressure, the valve mechanisms 124-127 will close, allowing hydraulic fluid to flow only through the restricted passage 122 at a restricted rate. Thus, enough reaction force is applied to a negative-pressure booster which amplifies the braking input, so that good brake pedal feel is maintained.

If hydraulic fluid is returned rapidly and violently from the wheel cylinders or the automatic brake control system, high back flow pressure will act on and open the relief valve 123. Thus, high back flow pressure is reliably released into the reservoir 8. This prevents excessive pressure from acting on the joint portions of the reservoir 8 and the cylinder body 1 or the secondary cup 12, thereby lowering the reliability of seals and cups.

In the embodiment of FIG. 6, the restricted passage 122 may be formed not in the valve seat 124b of the valve mechanism as shown, but in the center of the slit of the duck bill type relief valve.

In the embodiment of FIG. 7, as the restricted passage 122, a radial small-diameter hole may be formed in the cylindrical protrusion 8a of the reservoir 8 at its portion lower than the seal member.

While the valve mechanisms 124-127 shown in FIGS. 6-9 are all of a normally open type, they may be replaced with normally closed ones, in which each of the movable valves 124a, 125a and 126a is biased upwardly by a weak spring so that the valve mechanism opens when the pressure in the first and second pressure chambers falls below the atmospheric pressure.

1. A master cylinder comprising a cylinder body, a piston slidably received in said cylinder body to define a pressure chamber in said cylinder body, a reservoir coupled to said cylinder body, said reservoir having a downwardly extending protrusion formed with a hole through which the interior of said reservoir communicates with said pressure chamber, and a shoulder provided on said reservoir, and a valve body received in said hole, said valve body comprising a flat plate portion adapted to be moved into and out of contact with a bottom surface of said downwardly extending protrusion, thereby selectively opening and closing a fluid passage defined between said flat plate portion and said downwardly extending protrusion, and an elastically deformable extension extending upwardly from said flat plate portion and inserted in said hole, said extension having an engaging portion protruding upwardly from said hole so as to be engageable with said shoulder, said valve body being movable upwardly until said fluid passage is closed under a back flow pressure of hydraulic fluid toward said reservoir, said master cylinder further including a restricted passage through which said reservoir communicates with said pressure chamber when said fluid passage is closed.

2. The master cylinder of claim 1 wherein said restricted passage is an orifice formed in said flat plate portion of said valve body.

3. The master cylinder of claim 1 wherein said restricted passage is a groove formed in one of surfaces of said flat plate portion and said downwardly extending protrusion that are adapted to be moved into and out of contact with each other to extend from its outer edge to inner edge.

4. The master cylinder of claim 1 wherein said downwardly extending protrusion is formed with a first conical surface on its bottom end, and said flat plate portion is formed with a second conical surface on an upper portion of its outer periphery, said second conical surface being configured to be brought into sealing contact with said first conical surface, thereby closing said fluid passage.

5. The master cylinder of claim 1 wherein said valve body is made of a material having a greater specific gravity than hydraulic fluid, whereby said flat plate portion can separate from said downwardly extending protrusion under the weight of said valve body, thereby opening said fluid passage.

6. The master cylinder of claim 1 wherein said valve body is formed with a recess in a bottom surface thereof to bear said back flow pressure.

7. A master cylinder comprising a cylinder body, a piston slidably received in said cylinder body to define a pressure chamber in said cylinder body, a reservoir coupled to said cylinder body, said piston being configured to shut off communication between said pressure chamber and said reservoir when moved under an external force, thereby pressurizing hydraulic fluid in said pressure chamber and discharging the thus pressurized hydraulic fluid from said pressure chamber through an outlet port, and
a valve mechanism provided in a fluid passage through which said pressure chamber communicates with said reservoir, said valve mechanism comprising a flow restrictor through which hydraulic fluid can flow from said pressure chamber into said reservoir in a restricted amount while a back flow pressure of hydraulic fluid from said pressure chamber toward said reservoir is low, and a relief valve configured to open if said back flow pressure exceeds a predetermined threshold, thereby allowing hydraulic fluid to flow from said pressure chamber into said reservoir through said relief valve.

8. The master cylinder of claim 7 wherein said valve mechanism is configured to remain open, thereby opening said fluid passage, while the master cylinder is inoperative, and close when hydraulic fluid begins to flow from said pressure chamber toward said reservoir, thereby allowing hydraulic fluid to flow only through said flow restrictor, said valve mechanism further comprising a movable valve body and a valve seat, said flow restrictor being formed in one of said valve body and said valve seat, or defined between said valve body and said valve seat.

9. The master cylinder of claim 8 wherein said movable valve body of said valve mechanism is moved away from said valve seat under its own weight while the master cylinder is inoperative.

10. The master cylinder of claim 7 wherein said valve mechanism further comprises a movable valve body and a valve seat, said relief valve being an integral part of said movable valve body.

11. The master cylinder of claim 7 wherein said valve mechanism further comprises a valve body and a valve seat, said relief valve being a duck bill type valve comprising a slit formed in said valve body and configured to open if said back flow pressure exceeds said predetermined threshold.

12. The master cylinder of claim 7 wherein said relief valve comprises an elastic member which is an integral part of a seal member disposed between said cylinder body and a portion of said reservoir connected to said cylinder body, and a valve seat formed with a relief hole, said elastic member normally closing said relief hole, and being configured to separate from said valve seat, thereby opening said relief hole if said back flow pressure exceeds said predetermined threshold.

13. The master cylinder of claim 7 wherein said flow restrictor is provided on said reservoir.
